(19) United States
(12) Patent Application Publication
(10) Pub. No.: US 2006/0162178 A1
(43) Pub. Date: Jul. 27, 2006

(54) System for wireless local display of measurement data from electronic measuring tools and gauges

(76) Inventor: Philip Manuel Freidin, Sunnyvale, CA (US)

Correspondence Address: CENTRAL COAST PATENT AGENCY, PO BOX 187, AROMAS, CA, 95004, US

(21) Appl. No.: 11/045,943

(22) Filed: Jan. 27, 2005

(51) Int. Cl. G01B 5/00

(52) U.S. Cl. 33/784

(57) ABSTRACT

A system for acquiring and displaying data in a measurement process includes a local display unit enabled for wireless data reception, and a measuring tool for acquiring measurement data, the tool being enabled for wireless data transmission. The system is characterized in that the acquired data is transmitted from the measuring tool to the local display unit and displayed thereon.

### FIELD OF THE INVENTION

The present invention is in the field of measuring tools used in product prototyping, fabrication and production, and pertains particularly to systems and methods for local wireless display of measured data from measuring tools and devices.

### BACKGROUND OF THE INVENTION

In the art of fabrication of products there are a wide variety of machines and processes that are available and used in prototyping, fabricating, and manufacturing products of many materials, sizes, shapes, and dimensions. There are many different manufacturing arts of which selection for use in manufacturing depends on material specifications, dimensional requirements, and process requirements generally dictated by engineers, as those specific processes that will be needed to produce finished products.

Common and well-known manufacturing arts include, but are not limited to, the arts of metal working, including forming, stamping, sheet metal working, and metal machining. Plastic products may also require some form of machining, shearing, punching or stamping, and may also require other processes like molding, shaping, and so on.

While there are many processes performed on products for manufacture that are machine-controlled and automated, many of these processes require that initial parts be set up and verified manually.

Likewise, there are many semi-automated and manual processes that are used instead of fully automated processes for manufacturing parts. These include many machining processes like milling, turning, broaching, threading, form bending and the like. When manual and semi-manual fabrication processes are used, especially in the arts of metal working, a variety of specialized hand tools are required for the purpose of measuring dimensions of those parts throughout the various stages of manufacture.

Often parts that are being prototyped or first-run parts must be measured for dimensional integrity while they are positioned on or in a machine or are secured in some mounted position to be processed. Moreover, some products require multiple processes on different machines, with many measurement cycles interspersed in the overall processes before they can be finished.

Typical measurement tools for use in fabrication of products are hand-held instruments that have moving parts, position locks, calibration features, and measurement displays. Some of these tools have standardized scales engraved on the tool adapted to gauge dimension against a slideable or rotatable member of the measurement tool. An example of these types of tools includes well-known calipers, micrometers, inside diameter (ID) gauges and depth gauges. Some other types of measurement tools rely on a dial for visualizing measurement data. These types of tools include dial calipers, drop indicators, inclinometer, protractor, level, and dial indicators.

One problem with using these conventional tools in fabrication is that often measurements must be taken several times for a particular dimension in order to check repeatability of the reading. This is because these hand tools are often held in awkward positions when measuring dimensional features of stationary mounted parts. Often a fabricator cannot see the scale or dial when taking a measurement and must utilize a lock feature on the tool to render the measurement mechanism of the tool stationary before removing the tool from the set-up and then reading the scale or dial. A fabricator cannot be 100% sure in many cases that the tool did not move slightly when locking or even if the correct surface angle in relation to the part was achieved when taking the measurement. There are other situations where the measurement tool could not be removed from the measurement position if it is locked.

These problems may be exasperating to the fabricator, especially if close dimensional tolerances are critical to the process. In the art of machining, particularly mill work and lathe work, tight tolerances are often critical and can be called out in specifications down to +/−0.0001 of an inch. In some cases, conventional gauge and dial-bearing tools are not sufficient to measure extremely tight tolerances, especially when awkwardly held to measure a part mounted in a vise, for example, on a milling machine.

Other processes that cause difficulty when using conventional measurement tools are those used to prepare a machine and machine components for accurate performance. One such process is referred to in the art of machining as “tramming in” a milling head. The milling head must be in the correct vertical position in relation to the table bed in order to achieve close-tolerance thickness dimensions, for example, when fly-cutting a piece of stock. When “tramming in” the head of a vertical mill, a dial indicator and magnetic base or clamp base are typically used with the base affixed to the rotatable spindle portion of the head. The indicator tip is positioned to trace a wide circle on the bed just below the head of the mill. Due to the preferred angle of the indicator dial and tip positioned against the milling bed as it is rotated, when the display is 180 degrees opposite the fabricator, he or she cannot read the display easily, or at all.

Another common operation is mounting a vise and vise jaws so that they are positioned correctly on a milling table for use. Again, a dial indicator is a preferred tool. Using the indicator, the vise is checked for tram and the vise jaws are checked for parallelism with the moving milling table in the X and Y directions. The indicator faces away from the fabricator when checking the surface of the near jaw. Some dial indicators are available that have bidirectional tips, meaning that the display can be facing the fabricator when checking the near jaw, however, this may still prove inaccurate because the fabricator cannot see the near jaw surface the tip is traveling on.

In an attempt to improve accuracy and convenience of use many newer hand held measuring tools are powered by battery cells, or other means, and adapted with digital displays. These tools are calibrated and rely on one or more sensors that track and record movement of the measuring mechanism of the tool. Using this enhancement, such tools may be rendered more accurate and less prone to misreading. Such displays may also be zeroed out during any position of the measurement mechanism so that repeat measurements can be quickly compared to previous measurements. However, these tools still have a unidirectional display, meaning that the display is viewable only when the fabricator is facing it. Many measurements taken, for example, while a part is positioned in a setup on a milling machine or lathe are taken such that the display is facing away from the fabricator as previously described. The fabricator still has to remove the tool to read the display. In removing the tool, movement of measuring mechanisms may still occur, causing inaccurate readings. Removing the tool may not be desirable if multiple or continuous measurements are to be made.

The inventor is aware of some tools having a digital display where a statistical process control (SPC) port is provided that enables the tool to be tethered to a printer or computer so that data may be entered, for example, into a quality control program. These tools are used chiefly in quality control inspection processes after parts are finished and removed from the fabrication area. Such an implement would not be really practical for use in fabrication due to the inconvenience of the physical wire and stationary nature of the connected computer or printer station.

The inventor knows of another device, which is an LCD type display that can be tethered to a capacitive digital measuring tool having an SPC port. The device, referred to herein as a Guanglu device uses an oscillator to transfer data to the display. The display unit has a magnetic base and may be placed in a convenient location. However, a tether must be used to connect the device to the measuring tool, which is an inconvenience in the work area. Still another device is available and is known to the inventor for transferring data from a numerically controlled (NC) machine probe to a wired or wireless remote display unit. The device is described in a U.S. Pat. No. 4,437,240, referred to herein as Juengel et al. The display unit detects when the probe has touched a surface or edge and is used chiefly for edge finding and position location during initial gauging operations and the probe must be placed within the movable spindle or chuck on the machine head.

What is clearly needed in the art is a data transfer system that can be used with hand-held measurement tools for achieving convenient data display when tool displays are not visible to the fabricator.

### SUMMARY OF THE INVENTION

A system for acquiring and displaying data in a measurement process is provided. The system includes a local display unit enabled for wireless data reception, and a measuring tool for acquiring measurement data, the tool enabled for wireless data transmission, characterized in that the acquired data is transmitted from the measuring tool to the local display unit and displayed thereon.

In one embodiment, the wireless data reception and transmission is conducted over a radio frequency connection, an infrared connection, or an ultrasonic connection. In one embodiment, the wireless data reception and transmission is carried over a radio frequency connection and the band is one of the industrial scientific and medical (ISM) bands.

In one embodiment, the local display unit is magnetized on a portion thereof for convenient mounting on a metal display surface. In one embodiment, the local display unit is a calculator with an existing data input port enabled to receive the measurement data through a plug-in wireless adapter. In one embodiment, the local display unit is a calculator with an internal wireless chip and circuitry for reception of the measurement data.

In a preferred embodiment, the measuring tool is one of a micrometer, a caliper, a bore gauge, a dial indicator, an inclinometer, a protractor, a level, or a drop indicator having an internal wireless chipset and circuitry enabling wireless data transmission. In a variation of this embodiment, the measuring tool is one of a micrometer, a caliper, a bore gauge, a dial indicator, inclinometer, protractor, level, or a drop indicator having an existing output data port enabled to transmit the measurement data through a plug in wireless adapter.

In one embodiment, the local display unit has calculative capabilities adapted to perform calculations using received measurement data as one or more variables in a calculation. Also in one embodiment, fabrication involves mounting one or more work pieces to a machine tool and fabricating one or more features thereon the work piece features fabricated subject to measurement while mounted. In one embodiment, the system is used in machine-assisted production.

In one embodiment, the system includes additional measuring tools adapted to communicate to a single local display unit. In this embodiment, each additional tool is physically adapted for communication with the local display unit as required using a modular adapter. In one embodiment, the local display unit and measuring tool use frequency hopping to manage communication.

According to another aspect of the invention a wireless communication adapter for enabling a measuring tool to transmit measurement data to a local display unit is provided. The adapter includes a chipset and circuitry for enabling wireless transmission of measured data, a power source, and a connector for plugging the adapter to a port on the tool. In a preferred embodiment, the power source is a battery cell and the chipset includes a memory device.

In one embodiment, the chipset includes receive-circuitry in addition to transmit-circuitry. Also in one embodiment, the port on the tool is a statistical process control port. In an alternative embodiment, the port on the tool is a universal serial bus port.

In one embodiment, the connector includes a power pin and a command pin for deriving power from the tool and for sending commands to the tool through the port on the tool. In this embodiment the port on the tool may be a statistical process control port.

According to yet another aspect of the present invention, a method for displaying data measured from a work piece by a measuring tool is provided. The method includes steps for (a) positioning the measurement tool to take a measurement of a feature of the work piece; (b) recording the measurement data; (c) transmitting the acquired data wirelessly to a local display; and (d) displaying the data on the local display.

In a preferred embodiment, in step (a) the measurement data is taken from a feature of a work piece mounted in a machine tool. In one aspect, in step (a) the tool position renders the display or readable face of the tool not visible to an operator of the tool. In another aspect, in step (c) the transmitting step causes a mode shift from a power conservation mode or sleep mode to an active wireless transmission mode. In still another aspect, in step (c) transmitting the data occurs repeatedly over one or more channels for a pre-determined and timed sequence.

In one aspect the method further includes a step (e) for acknowledgement of transmission success, the acknowledgement sent back to the tool. In one aspect of the method, the local display is one of a liquid crystal display or a light emitting diode display capable of numeric display capability, graphic display capability, or both numeric and graphic display capability. In still another aspect a further step is provided for using the received data as a variable in a calculative sequence.

In one embodiment referring now to the system described further above, the wireless protocol used is Bluetooth™ or Zigby™. In still another embodiment regarding the system, the measurement tool is a tool adapted to monitor resistance of a strain gauge and to record differences in resistance caused by deflection of a leaf spring supporting the strain gauge. In a variation of this embodiment, the leaf spring supports more than one strain gauge.

### BRIEF DESCRIPTION OF THE DRAWING FIGURES

FIG. 1 is a plan view of a digital micrometer and display according to prior art.

FIG. 2 is a plan view of the micrometer of FIG. 1 adapted for wireless data transmission to a local display unit according to an embodiment of the present invention.

FIG. 3 is a block diagram illustrating components for wireless data communication with a local display unit according to an embodiment of the present invention.

FIG. 4 is a block diagram illustrating a local display unit according to another embodiment of the present invention.

FIG. 5A is a block diagram illustrating communication between an LDU and measurement tool according to one embodiment of the present invention.

FIG. 5B is a block diagram illustrating communication between an LDU and measurement tool according to another embodiment of the present invention.

FIG. 6 is a process flow chart illustrating steps for capturing a measurement and displaying the measurement locally according to an embodiment of the present invention using wireless transmission.

FIG. 7 is a perspective view of a deflection-sensitive measurement tool according to an embodiment of the present invention.

FIG. 8 is a perspective and broken view of a deflection-sensitive measurement tool according to another embodiment of the present invention.

FIG. 9 is a block diagram illustrating components of the tool of FIGS. 7 and 8 according to an embodiment of the present invention.

### DESCRIPTION OF THE PREFERRED EMBODIMENTS

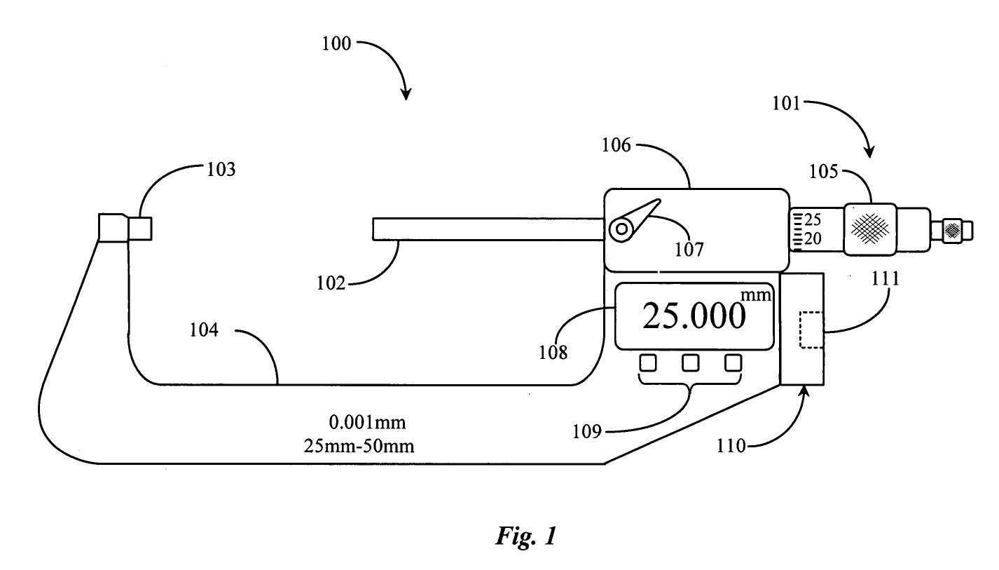

FIG. 1 is a plan view of a digital micrometer 100 and display according to prior art. Micrometer 100 is typical of a hand-held measurement tool used by persons in the art of machining of metals and other commonly machined or formed materials. Micrometer 100 has a rotatable and geared adjustment member 101 that is adapted to control the linear movement of a stainless steel shaft appendage 102. A micrometer tip 103 is adapted to abut against one surface of a material or work piece feature being measured, typically for thickness. Turning adjustment member 101 has a barrel feature 105 that has a scale engraved thereabout with a portion typically enlarged and crosshatched for user grip. Turning feature 105 clockwise moves member 102 toward the material or work piece until the end surface of member 102 makes contact with the opposite surface of the feature being measured. The measured distance between the stationary micrometer tip surface 103 and the end surface of member 102 is the sought-after measurement.

Micrometer 100 in this example has a metal frame 104 and a barrel housing 106 protecting delicate parts, as is typical with most micrometer measuring tools. A user may read the current measurement directly from the barrel portion of the tool. In this particular example micrometer 100 also is adapted with a digital display 108 and the required circuitry, power source, and sensor units to enable the measurement to be displayed for convenience. Display 108 may be a liquid crystal display (LCD), a light emitting diode (LED) display or another type of display. As is well known, micrometers are typically provided in 0 to 1 inch models, 1 to 2 inch models, and so on up the scale. Barrel 105 has a lock lever 107 provided thereto and adapted to enable friction locking of the barrel, restraining movement of shaft 102.

Display 108 is associated with an array of user input buttons or mode buttons 109 that are each adapted for controlling certain functions. For example, one of buttons 109 may be a power on/power off button. Another of buttons 109 may provide for zeroing or clearing display 108 while still another one may provide a toggle between metric and inch standards of measurement for display. Circuitry for the display 108 and buttons 109 are contained within the frame 104 and barrel housing 106.

In this case micrometer 100 is adapted with a data port 111 and circuitry housing 110. Data port 111 may be a statistical process control (SPC) port with supporting circuitry (within housing 110) typically provided only to those instruments used in large quality control (QC) operations. The SPC circuitry may be merged with the display circuitry within frame 104 and barrel housing 106, and circuitry housing 110 is not specifically required. Data port 111 may be located within frame 104. That is to say that a serial connection, typically a wire connector cable, may be used to tether micrometer 100 to a machine display, typically a quality control workstation or computer for repeated measuring of a same feature for plural entry into a software program that counts the measured parts and records the percentage that are out of tolerance.

Micrometer 100 may be used as a hand tool without SPC functionality. Micrometers routinely used in the fabrication area of any enterprise do not have SPC functionality, as it would be impractical for application to set-up operations and to close-tolerance measurement taking of features of mounted work pieces that are in process. This is because the SPC function itself is geared to a single measurement taken repeatedly for machine discernment. Likewise, fabrication-area measurement tools are not SPC-enhanced because of limitations a connected hardwire would impose on physical mobility and positioning of the tool for measuring features of a mounted work piece. One with skill in the art of machining will understand that there are many difficult and sometimes awkward positions that a typical measurement tool such as a micrometer must be positioned in, in order to successfully measure a feature of a mounted work piece.

Although this prior-art example is representative of a micrometer, a micrometer is just one of many varied hand-held instruments that are typically used in the practice of fabrication and that may be enhanced according to methods and apparatus of the present invention. Micrometers themselves sometimes exhibit other features not illustrated herein like having removable anvils in place of a micrometer tip such as on an anvil micrometer.

Some other common hand-held measurement instruments that may be enhanced for practicing the present invention included but are not limited to dial calipers, depth micrometers, and inside diameter (ID) gauges also termed bore gauges in the art. Likewise, machine mountable measurement instruments commonly used for set-up and run operations include dial indicators, drop indicators, and tabletop height gauges. The inventor chooses a micrometer for illustrative purposes only and that it is one of the most well known and commonly used measurement tools.

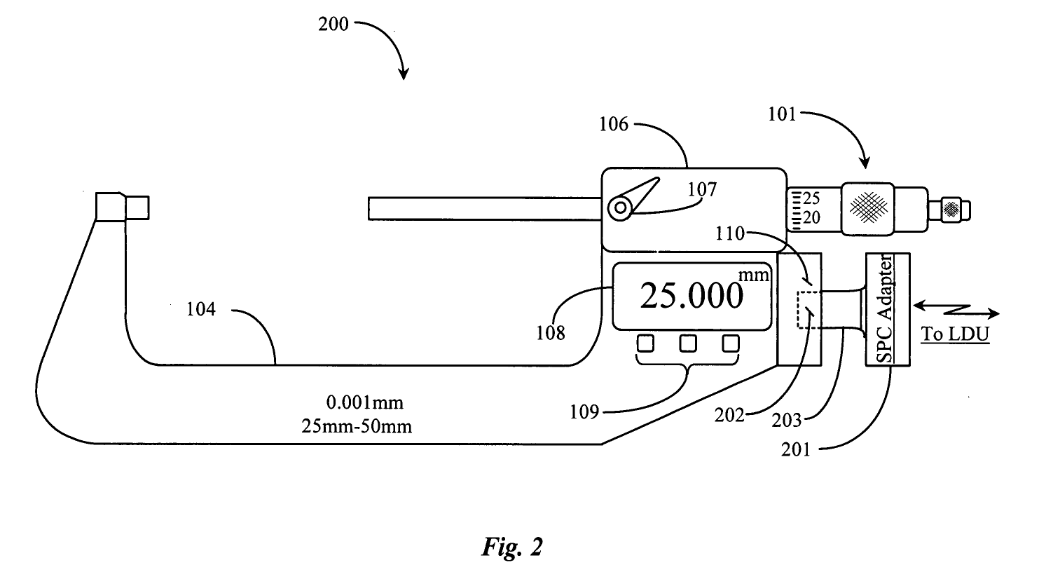

FIG. 2 is a plan view of a micrometer 200 adapted for wireless data transmission to a local display according to an embodiment of the present invention. Micrometer 200 is analogous in basic construction and many features to micrometer 100 described above. However, in this example micrometer 200 is adapted for wireless transmission of measurement data to a local display unit (LDU) according to an embodiment of the present invention using wireless data transmission.

An SPC adaptor 201 is provided for adapting micrometer 200, which has an SPC data port, for wireless transmission of output data. Adaptor 201 comprises a housing for internal circuitry and a short flexible wire/plug appendage 203, which in one embodiment, is adapted as a plug that is compatible to an existing SPC port. Appendage 203 may be insulated using rubber, polymer, vinyl or other suitable material. In this example, data measured and displayed on display 108 is output to adapter 201 through appendage/plug 203 for wireless transfer to an LDU using a wireless data transmitting mechanism, such as radio frequency (RF), Ultrasonic, Infra Red (IR) or other available methods.

SPC adapter 201 comprises all of the circuitry including a wireless chip-set for receiving SPC data and resending that data for display on an LDU, which in a preferred embodiment, is conveniently mountable to a visible surface of a machine or other location in near proximity to an operator and in the operator's field of view. SPC adaptor 201 may be adapted, in one embodiment, to receive data and to transmit data back to a connected measurement tool such as to micrometer 200. In one embodiment, adapter 201 is adapted only to send data to an LDU.

In one embodiment, SPC adapter 201 is modular as in this example and can be removed from micrometer 200 and subsequently plugged into an SPC port on another tool when that tool is required for use. SPC adapter 201 and appendage 203 are provided in a size-appropriate manner so that an operator may, without inconvenience, use micrometer 200 to take measurements in awkward positions as he or she would using a typical hand-held measuring tool. SPC adapter 201 may, in one embodiment, be encased in a shock-resistant rubber boot or other non-corrosive material.

In one embodiment of the present invention, SPC adaptor 201 may be provided simply with an SPC plug that fits into the existing SPC port and appendage 203 is not specifically required. In some embodiments, for example, a machinist or other operator may have all of his or her hand-held measurement tools adapted for wireless transmission wherein each tool has a unique SPC adapter like adapter 201.

In another embodiment of the present invention, hand-held measurement tools may be provided with internal circuitry enabling local data display (or not) and wireless transmission of that data to an LDU. It will be apparent to one with skill in the art that new tools may be provided with all of the necessary circuitry for enabling display on the tool and/or local display of measured data over a wireless data link to an LDU from that tool. In this case SPC ports are not specifically required in order to practice the present invention. The inventor illustrates an SPC adapter only as one embodiment that is convenient because it leverages existing SPC port circuitry and capabilities requiring no tool modification.

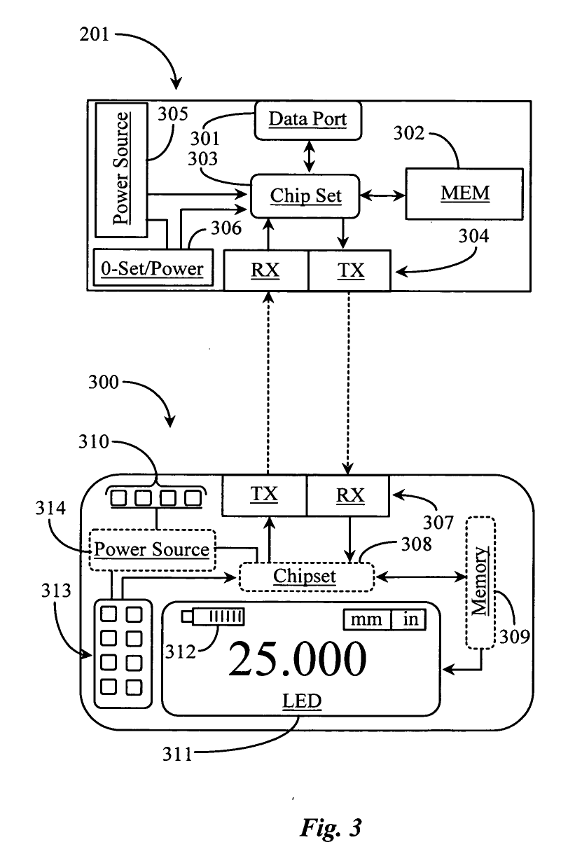

FIG. 3 is a block diagram illustrating components for wireless data communication with a local display unit according to one embodiment of the present invention. Adapter 201 has a data port 301 adapted to receive data from a measurement tool such as from micrometer 200 described further above. A wireless chipset 303 is provided within adapter 201. Chipset 303 contains all of the micro circuitry required to enable wireless data transmission over a wireless data link established between itself and another chipset. Chipset 303, in one embodiment, may be part of a micro controller that includes all of the transmission and receiver port circuitry illustrated herein as RX TX 304. Chipset 303 may contain programmable firmware (not illustrated) that enables programming input for enabling unidirectional (transmit only) or bi-directional communication.

Adapter 201 has a memory 302, which may also be a data queue, such as a first-in-first-out (FIFO) queue. Memory 302 may hold data for transmission and received data for implementation in a bi-directional embodiment. Adapter 201 has a power source 305, which may be a battery or rechargeable cell. In one embodiment, power source 305 is not specifically required. In this embodiment, power may be derived from a host device such as digital micrometer 200 described further above if port 301 contains a power pin.

Adapter 201 in this example has a user input panel 306 provided and adapted to enable limited user input to the device, such as powering the device on and off and setting the host measurement display to zero at any measurement position if so equipped. A command line may be provided to communicate one or more commands to a host tool through data port 301.

In one embodiment of the present invention, adapter 201 does not contain a data port 301 adapted to communicate with a host port on a measuring instrument. In this embodiment, adapter 201 may be provided as a built-in module for any powered digital measuring tool with or without a local display. In this case, movement sensors communicate directly to the chipset for transmission through TX 304. Any mix of data caching and queuing using flash memory, random access memory, and the like can be provided. In a typical implementation, a standard data queue for staging and queuing transmission packets for send is sufficient.

Adapter 201, in a preferred embodiment, communicates with an LDU 300. LDU 300 is adapted as a local display that can be conveniently placed, mounted or otherwise hosted at a workstation or machine for displaying dimensions taken by and communicated thereto from a measuring tool equipped with adapter 201. LDU 300, may be placed as close as one or two inches from a measuring tool communicating therewith without departing from the spirit and scope of the present invention. The only limit to the maximum distance an LDU may be placed from a communicating tool is the range capability of the wireless transmission chipset. LDU 300 may have a magnetic base for application to a vertical surface of a machine cabinet or housing such that it is within convenient viewing range of an operator.

LDU 300 has a wireless chipset 308 adapted to communicate wirelessly to chipset 303 including circuitry 307 for transmit (TX) and receive (RX). Chipset 308, like chipset 303, may include a memory 309, which may be a data queue adapted to queue received packets for display and to stage and queue any packets for send to adapter 201. In one embodiment, a data queue and a separate data caching capability is provided.

A power source 314 is provided within LDU 300, which may be one or more batteries or rechargeable power cells. In one embodiment, LDU 300 may be powered from a mains power electrical outlet without departing from the spirit and scope of the present invention. A user input panel 310 is optionally provided on LDU 300 and contains one or more user-operable inputs for sending commands to the unit. For example, a power on/power off button may be provided as well as a set-zero button. Another button may be provided for enabling toggling of metric or inch standards with respect to data display. Still another button may be provided to accept a new device configured with an adapter and to add that device (adapter or measuring tool with internal circuitry) to a list of devices that may communicate with LDU 300.

In one embodiment of the invention, LDU 300 has a calculation input panel 313 provided and adapted to enable an operator to take wireless data measurements from a device to be used as data input for a calculative function performed with the data, wherein the calculation result may be displayed using an LCD or LED type display 311. Display 311 may also contain certain alert display capabilities like alerting the operator of the charging status of batteries or power cells. Display 311 may also be able to display data graphically without departing from the spirit of the present invention. Likewise, a variety of functions can be incorporated for display like current date and time, number of devices active in communication with the unit, a measurement in excess of a preset threshold, and so on.

In a preferred embodiment of the present invention, adapter 201 and LDU 300 communicate over the industrial scientific and medical (ISM) band at 2.4 GHz. The ISM band at 2.4 GHz actually ranges from 2.4000 GHz to 2.4835 GHz. Therefore, the preferred band can support up to 84 channels, each 1 MHz wide. The preferred band mentioned should not be construed as a limitation of the present invention. Many other RF frequencies may apply as well as other wireless technologies and protocols as mentioned above. ISM is just one example of a frequency band that will support sufficient channels to adequately practice the invention.

In a preferred embodiment, one LDU may be adapted to communicate with a number of measurement tools adapted for wireless communication via adapter 201 or internal chipset and circuitry. In a case of multiple instruments simultaneously able to communicate measurement data to a single LDU, each instrument may have its own unique adapter ID. In another embodiment, an operator has one adapter 201, which may be plugged into and removed from the operator's measurement tools such that it may be moved from tool to tool when in use and communicating.

Unique adapter IDs (addressing) apply in a case where one adapter is allotted to one specific tool and a next adapter is allotted to a next tool. The chipset ID or addressing data may be burned into the chipset during manufacture, or in one embodiment, it may be programmed into firmware on the chipset by an operator. Likewise, each LDU deployed has a unique ID. IDs may be a MAC address similar to an Ethernet address.

Transmission between slave devices (measurement tools) and a master unit (LDU) may follow a variety of known transmission protocols and synchronization schemes to ensure that measurement tools communicating with one LDU are not acknowledged by another LDU operating within range of the first one or by some other interference from an existing wireless local area network (WLAN) transmissions from other types of devices operating in the same ISM band. More detail about data transmission according to one or more embodiments will be provided later in this specification.

One with skill in the art will recognize that a convenient and accurate LDU placed in a convenient and visible location can display measurement data from a tool that is positioned in a setup such that a local display on the tool is not visible. A manual send button may be provided on an adapter body (adapter 201) or on the LDU body so that the only time the link is active is when a measurement is being actively recorded and displayed. In this way, the devices use the minimum power required to transmit and display a measurement. In the case of a dial indicator adapted for practice of the present invention a send command may be initiated from LDU 300 so that an operator does not have to physically touch the tool taking the measurement and thereby risk an incorrect measurement. On other hand-held tool like micrometers and calipers, a manual data send function may be physically initiated at the point of the tool without affecting accurate measure.

In one embodiment of the present invention, the adapter may transmit the measurement data whenever the tool indicates a new value. When the measurement data stops changing, the transmission stops and the adapter may enter the sleep mode automatically.

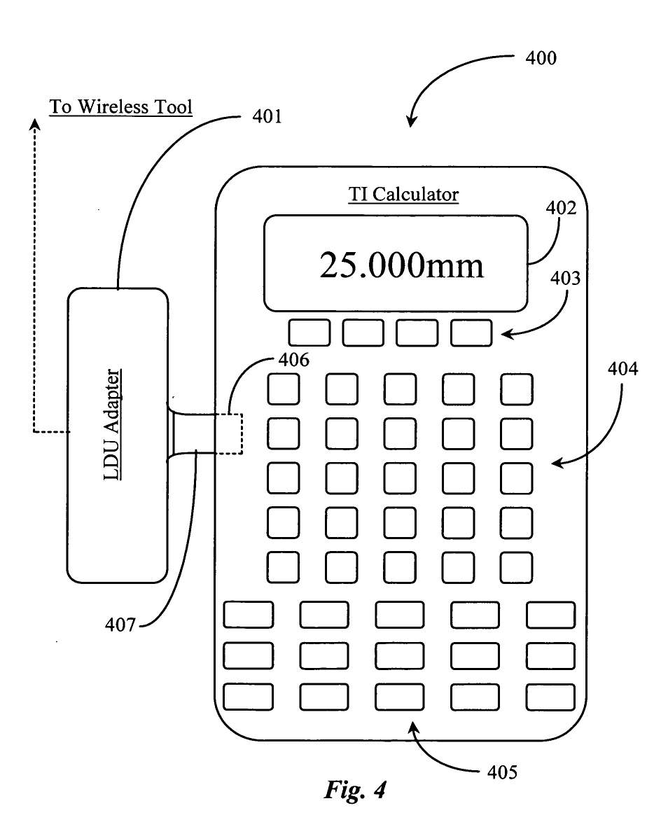

FIG. 4 is a block diagram illustrating a local display unit 400 according to another embodiment of the present invention. LDU 400 is, in this example, an electronic hand-held calculator of a type commonly used by machinists and or fabrication specialists in the field. Calculator 400 has a data port 406 provided thereto and adapted to at least receive wirelessly transmitted data for display on an LCD or LED display window 402. In this case an adapter 401 is provided in a similar fashion as was described with respect to adapter 201 of FIG. 2. That is to say that adapter 401 may be very similar, and in some cases physically identical to adapter 201 that plugs into an output data port on a measurement tool. Therefore, adapter 201 may be deployed at the point of a measurement tool while adapter 401 is deployed at the point of an operator's calculator, enhanced in this embodiment as an LDU capable of at least receiving and displaying wirelessly transmitted data.

In one embodiment of the present invention, adapter 401 is similar to LDU 300 of FIG. 3, except instead of having a display 311 and input panels 310 and 313, it uses the calculator's display 402, and input panels 403, 404, and 405.

The data transfer protocol of port 406 of calculator 400 may be defined by the calculator manufacturer. LDU adapter 401 may convert the data it receives from the measurement tool via adapter 201 to the data transfer protocol of port 406. In still another embodiment internal circuitry and port circuitry comprising a wireless chipset and USB port circuitry may be provided as generic features of newly provided measurement tools wherein the LDU is also adapted with USB capabilities. In this embodiment, a standard computer device or any other device with USB capability may be used to display measurement data from a tool. In this embodiment unidirectional transmission from tool to LDU may be preferred to conserve power and any additional circuitry and software or firmware required for two-way transmission.

In a preferred embodiment a measurement tool adapted according to an embodiment of the present invention is dedicated to report while an LDU is dedicated to receive and display data. Also preferred is that the transmission be conducted only when there is accurate data to report. However, that does not preclude a more robust implementation where both transmit and receive functions are enabled in bi-directional fashion over the established wireless link.

Adapter 401 plugs into calculator 400 using flexible appendage 407 adapted with a plug. Appendage 407 may be a rubber or polymer or a vinyl insulated cable. In this example, calculator 400 is adapted to display data from a measurement tool using the display window 402 through adapter 401. The display may include graphical as well as numeric display capability. In another embodiment, internal chipset and circuitry enabling wireless data receive and display functions may be built into calculator 400. In other embodiments where a calculator or another digital device having a micro controller and a display window also has an existing data port for accepting wired data transmission from an external source, that data port may be adapted for accepting wireless data according to an embodiment of the present invention.

Calculator 400 has a standard input function panel 404 adapted to provide calculative input for standard mathematical and statistical functions. Calculator 400 also has a scientific function input panel 405 adapted to enable more complex scientific functions including trigonometric functions such as computing sine cosine, tangent, and cotangent. A standard input indicia panel 403 is provided to enable standard functions like power on, power off, clear, and recall.

In one embodiment, calculator 400 is capable of accepting one or more wirelessly transmitted measurements from one or more measurement tools and then to apply the measurement variable or variables to one or more computations producing a data result for display. In such an embodiment, a formula for computing a specific result may be pre-programmed into calculator 400 for automated computation upon receipt of the one or more variables transmitted thereto from one or more measurement tools. In one embodiment, a separate piece of firmware or software may be provided to calculator 400 to enable specific functions.

In one embodiment, wirelessly transmitted variables representing measurements taken may be received and then manually stored for later use by calculator 402. In this embodiment such variables may be selectively and independently displayed or may be aggregated for a grouped display before using those variables in any computations, upon which the computed result may be displayed.

One example of a computed result that may depend on wirelessly transmitted variables may be to find a centerline-to centerline distance between two bores through a material surface. Each bore may be measured for diameter and transmitted to calculator 400 from a bore gauge adapted for wireless communication to calculator 400 according to an embodiment of the present invention. Those variables may then be stored for use in a computation. Next, the closest edge-to-edge dimension related to distance between the bores might be taken using a caliper or an anvil micrometer adapted for wireless communication to calculator 400. Upon receiving the smallest edge distance between the bores, calculator 400 may automatically calculate the radii of both bores and add the result to the distance dimension providing the center-to center dimension sought. Other calculation operations are also possible such as gauging threads produced by a screw machine for example. Other operations may include or may be enhanced by the calculators ability to do table look-ups and displaying variable results.

One with skill in the art will recognize that there are many possible computations that are commonly performed through manual measurement and then subsequent data entry and calculation. The present invention enables much work reduction related to data acquisition and entry of that data into a computing device in order to compute equation results.

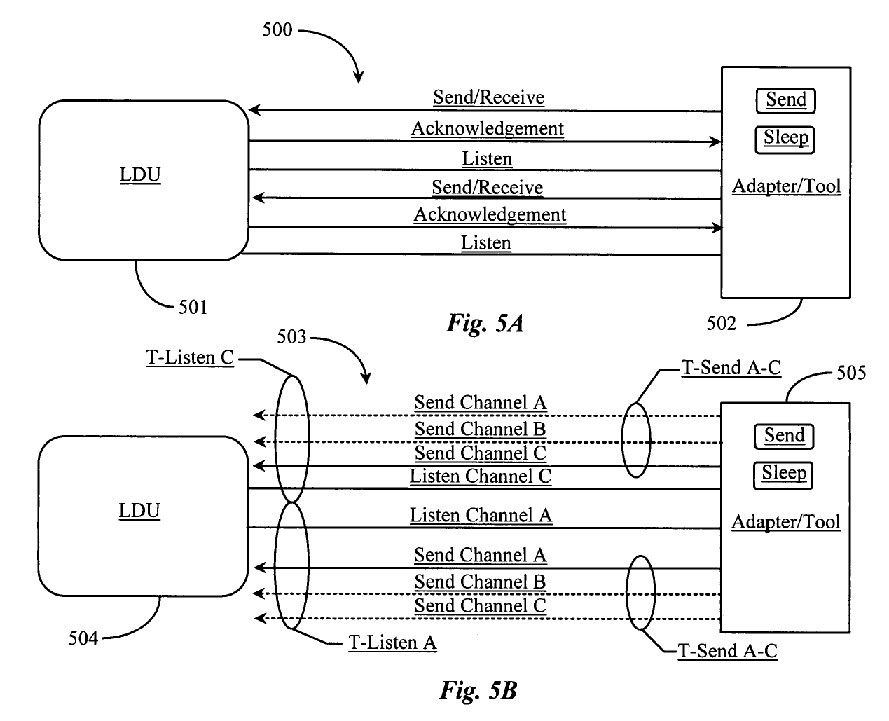

FIG. 5A is a block diagram 500 illustrating communication between an LDU and measurement tool according to one embodiment of the present invention. Diagram 500 includes an LDU 501 analogous to LDU 300 or LDU 400 described further above and an adapter/tool 502 analogous to adapter 201 of FIGS. 2 and 3 or of an internal implementation of this function provided within a measuring tool of a compatible type.

In this example, LDU 501 is adapted with a communication protocol that requires an acknowledgement to be sent back every time a data packet is received from the adapter/tool. It is noted herein that it is not necessarily preferred that adapter/tool 502 be actively sending data over a persistent wireless link. Persistent and continuous connection and communication activity may drain or severely limit power attributes of the measuring tool.

In this example, tool 502 is provided with a manual send mode and a sleep mode (low power consumption). When an operator determines that a specific measurement should be sent to LDU 501, the send command may be initiated from the adapter or tool itself (depending on configuration). Similar to a walkie-talkie transmission, pushing send generates a transmission of the current measurement to LDU 501 over a configured channel within the band. The LDU receives the packet in the same transmission and then sends an acknowledgement back to tool 502 confirming the transmission success. In this case only one transmission has to be sent from the tool. If an ACK packet is not received by the tool from the LDU within a pre-configured time period then the data may be resent. Another example would have the tool automatically send the data whenever the measured value changes.

After sending the measurement data, the operator may place tool 502 in sleep mode until the next time a measurement must be taken and transmitted. In another possible embodiment of this present invention, the sleep mode may be entered automatically after sending the measurement data. In sleep mode, tool 502 consumes the least amount of power because it is not actively transmitting any data or listening to any RF channels. In the meantime, LDU 501 is configured to actively listen over the assigned channel until it receives another packet from tool 502, at which time an acknowledgement is sent confirming transmission success. This same protocol may be used for multiple tools talking to a same LDU using the same or a variety of assigned channels. If by some external interference, a channel is jammed when tool 502 is attempting to send a packet, then no acknowledgement will be received and the packet may be resent until it is received and acknowledged.

FIG. 5B is a block diagram 503 illustrating communication between an LDU and measurement tool according to another embodiment of the present invention. Diagram 503 includes an LDU 504 analogous to LDUs 400 or 300 described above and an adapter/tool 505 analogous to adapter 201 of FIGS. 2 and 3 or of an internal implementation of this function made a generic part of a measurement tool. In this example, the same send and sleep modes are provided. A difference is in the way transmission is achieved. In this example, frequency hopping is practiced. Frequency hopping involves sending packets over more than one channel in order to insure that one of those multiple packets may be received.

When an operator is ready to take a measurement and transmit the data to LDU 504, he or she may initiate the send mode on tool 505. At this point device 505 will attempt to send the measurement data repeatedly using different channels for each send. In this example device 505 sends data first over channel A and then over channel B and then over channel C. It is noted herein that in actual practice there will likely be many more available channels for frequency hopping then 3 channels. For example, 84 channels were described as available in the discussion further above with respect to FIG. 4. The inventor just illustrates 3 channels in this example and deems the illustration adequate for explanatory purposes.

The time for sending the same measurement data over channels A-C is expressed as T-Send A-C and represented by an ellipse. During the send operation using the 3 channels, LDU 504 is actively listening to channel C. The time LDU listens to channel C is expressed as T-Listen C and is represented by a larger ellipse. T-Listen C is greater than T-Send A-C such that eventually one transmission (Send Channel C) comes through on channel C. Sends A and B were not received. In a preferred embodiment LDU 504 selects a channel in the hopping frequency A-C that has no current interference. After listening to C, LDU will begin listening to channel A for a same greater period of time over T-Send A-C. The next opportunity to transmit a new measurement arrives and T-Send A-C is executed again. This time the successful transmission is received over channel A.

It is noted herein that there are many different frequency-hopping scenarios that may be applied to this example without departing from the spirit and scope of the present invention. For example, the frequency hopping channel order may be the same order for each transmit and listen function and may occur during a same time window. In one embodiment after an nth transmission sent by a measuring tool, an acknowledgement may be sent back acknowledging that at least one of the transmissions was received. If no acknowledgement arrives, the measuring tool may resend the same data using the next sequence of channels. Moreover, the measuring tool may be configured to send twice over each channel and the time in between each send over one channel may be configured to be a greater time than a known transmission time of an interfering device using the same frequency band. Frequency hopping may be used even if there is no interference, to meet the regulatory requirements of using the ISM band.

The receiving unit (LDU) may be configured for random frequency hopping or pseudo-random frequency hopping without departing from the spirit and scope of the present invention. In still another embodiment of the present invention, a spread spectrum or ultra wide band transmission scheme may be used in place of frequency hopping. There are many possibilities using a variety of schemes or a combination of schemes to manage communication between multiple measurement devices and an LDU. Multiple LDUs each configured to communicate with one or more measurement tools may be operated in relatively close proximity such as adjacent workstations.

A large fabrication area may have several systems operating during any given work period. In typical fabrication scenarios, from 1 to 5 measurement tools may be required during a particular job, all of which may have unique adapters that all communicate with one host LDU. In another embodiment, one measurement tool is used at a time with one adapter modularly switched from tool to tool by plugging into an existing data port on each tool. In another embodiment, each measurement tool communicates to a different LDU. There is a range of possibilities.

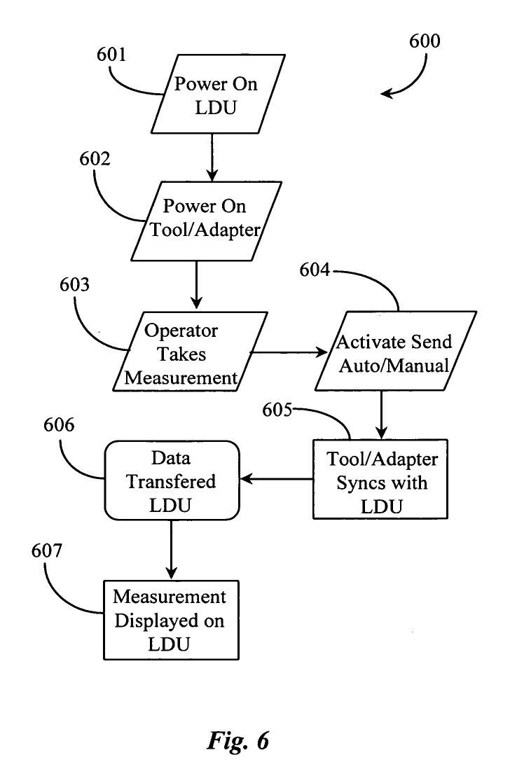

FIG. 6 is a process flow chart 600 illustrating steps for capturing a measurement and displaying the measurement locally according to an embodiment of the present invention using wireless transmission. At step 601, an operator powers on an LDU analogous to LDU 300 of FIG. 3 or to LDU 400 of FIG. 4. At step 602, the operator powers on an adapter analogous to adapter 201 of FIG. 2 plugged into an existing data port on a measurement tool or a measurement tool equipped with internal circuitry. At this step the adapter or tool may, optionally, be set to sleep mode meaning that although it is powered on there is no wireless connection yet established between the tool and the LDU. At step 603, the operator positions the tool over a work piece feature to be measured and takes a measurement. At the position of measurement with the tool in place or the measurement taken locked at position using an existing friction lock on the tool, the operator activates a send option on the tool or adapter at step 604 to transmit the current measurement data or this may happen automatically. The data may also be displayed locally on the tool, although the operator may not be able to see the tool display.

At step 605 the tool or adapter synchronizes with the LDU and establishes wireless connection. At step 606, the measurement data is transferred to the LDU. In this step the data may be repeatedly transferred in a timed sequence over one or more channels. Optionally, an acknowledgement packet may be sent back to the adaptor or tool to acknowledge data receipt. At step 607, the current measurement data is displayed on the LDU display for the operator to view. In some cases, a further step enables the data to be manipulated in some calculation pre-programmed on the LDU.

One with skill in the art will recognize that the method and apparatus of the present invention enables much work reduction when utilizing hand-operated measuring tools in a fabrication environment where awkward tool positions routinely occur. The ability to conveniently view measurement data on an LDU enhances ergonomic status in work production and improves safety and accuracy during fabrication.

The method and apparatus may be practiced using a number of wireless communication technologies such as RF, Ultrasonic, Infrared, and so on. Likewise, data from the work area may in some embodiments, be forwarded to another department, such as quality control using WLAN method. In this way, QC personnel may monitor, for example, first piece measurement data before a part is submitted for inspection.

Leaf Deflection Measurement Tool and Wireless Transmitter

According to one aspect of the present invention, the inventor provides a novel measuring tool similar to an indicator that derives measurement data from a set of measured capacitive or resistive values associated with a flexible member having contact with a capacitor or with one or more resistive stain gauges.

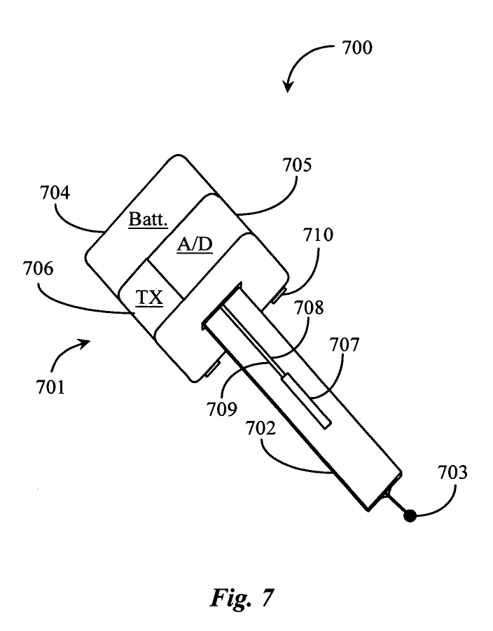

FIG. 7 is a perspective view of a deflection-sensitive measurement tool 700 according to an embodiment of the present invention. Measurement tool 700 is provided for taking measurements and transmitting those measurements taken to an LDU analogous to those described further above. Tool 700 has a housing 701 adapted to contain the required circuitry for processing measurement data and for transmitting that data to a local display unit according to preferred embodiments.

Housing 701 has a compartment or space 704 adapted to contain a power source such as a battery or rechargeable power cell. A compartment or space 705 is provided for containing or housing circuitry for analog to digital data conversion and other data processing. A compartment or space 706 is provided within housing 701 and is adapted to contain the TX circuitry and wireless chipset for transmitting measurement data to an LDU.

In this embodiment, housing 701 is provided in a form that is magnetized on a portion thereof for enabling an operator to place the tool in a fixed manner on a magnetic surface. Magnet strips 710 are provided for the stated purpose. In other embodiments, housing 701 may be provided in other forms for facilitation of varying applications.

Tool 700 has a metallic leaf 702 provided thereto and affixed at one end to housing 701. Leaf 702 may be fabricated from a spring steel or other metal that has a strong memory characteristic regarding flex. Leaf 702 may be aligned substantially parallel to housing 701 in a manner that a portion thereof is secured within housing 701 by clamp, weld, bolt, or other mechanism. In a preferred embodiment, leaf 702 assumes a perpendicular profile to housing 701. However in other embodiments, the perpendicularity profile of leaf 702 may be adjustable such as by turning one or more set screws (not illustrated).

Leaf 702 may be provided in various sizes and thickness, however in one preferred application leaf 702 is approximately 0.010″ thick, 1.00″ long and one-quarter inches wide. In this example, leaf 702 is rectangular having substantially parallel sides, however it is not required to practice the present invention as long as the shape of leaf 702 enables retention of original profile after application of force to bow leaf 702 in either direction.

Leaf 702 has a resistive strain gauge 707 affixed thereto on one side with a suitable epoxy. Strain gauges are well known in the art and are used to measure different types of strain that may be subjected to a work piece or component of a system. There are many types, sizes and configurations of stain gauge implements. In a simplest embodiment, tool 700 has a single strain gauge affixed in a strategic position on one side of leaf 702. In more complex embodiments, more than one gauge, like gauge 707 may be provided and both sides of leaf 702 may support one or more such gauges.

Leaf 702 has an indicator tip 703 provided thereto and either permanently or removably affixed at the flexible end of leaf 702. Indicator tip 703 is similar to a dial-indicator tip having a ball end and a length of shaft. However, many different tip configurations may be utilized without departing from the spirit and scope of the present invention including varying ball size, shaft length, and so on. The method of affixing tip 703 to the end of leaf 702 may be by weld or in a removable embodiment, by screwing the tip on to a permanent base structure affixed at the end of leaf 702.

In a preferred embodiment, tool 700 is used much in the same way as a dial test indicator is used to measure surface deflection along a work-piece surface. In one embodiment, a lathe application is provided wherein the housing is adapted to be held in a 3-jaw chuck or tail stock apparatus.

In this embodiment, tool 700 is adapted for millwork and other fabrication applications typically involving vise placement or mounting of work pieces. The resistance of strain gauge 707 is a function of the strain that the gauge undergoes as a result of flexing the leaf 702 that it is attached to. Wires 708 and 709 supply an excitation voltage that will be modified as a result of the change in resistance of the gauge. The change in voltage is processed by the circuitry within housing 701 to derive a measurement of the amount of deflection in leaf 702. In one application, the total allowed deflection for leaf 702 may not exceed 0.040 or 0.020″ of strain in either direction. However, in different configurations, different deflection totals may be allowed without departing from the spirit and scope of the present invention.

Circuitry within housing 701 processes the resulting deflection measurement into a metric or inch standards value and transmits the results to a local display unit for the operator.

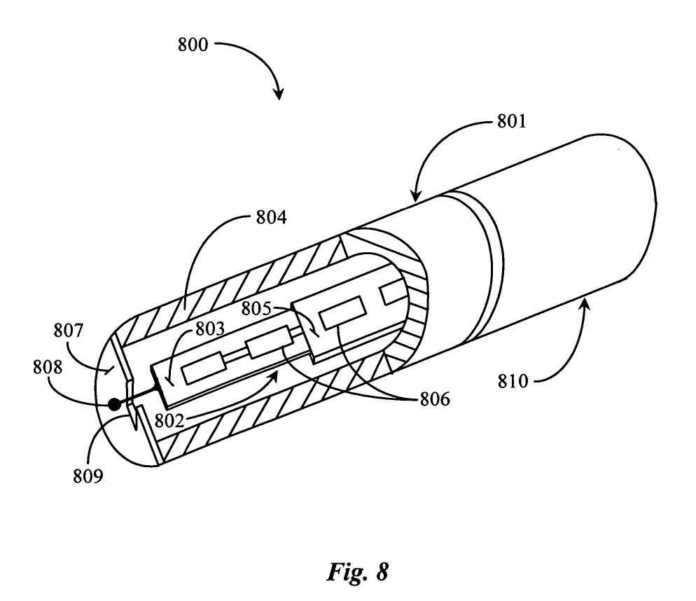

FIG. 8 is a perspective and broken-view of a deflection-sensitive measurement tool 800 according to another embodiment of the present invention. Tool 800, like tool 700 described above is adapted to be used much like a dial test indicator. Tool 800 is adapted with a cylindrical tail portion or housing 810 to be held in a cylindrical collet such as a spindle collet, a collet from a collet block, a jaw-chuck, drill chuck or tail chuck, or other mechanism adapted to station work pieces or tools having cylindrical anterior profiles adapted for the purpose.

Tool 801 has an optional leaf/beam structure 802, which comprises a thin metallic leaf 803 affixed to a somewhat thicker beam structure 805. Leaf structure 803 is analogous to leaf 702 of FIG. 7 and includes a dial tip 808, which is analogous in description to tip 703 of FIG. 7. At the end opposite the free end of leaf 803, beam 805 serves as a mechanical divider in one embodiment. In this case, there may be no strain gauges 806 provided directly to leaf 803. Instead gauges 806 may be provided to beam structure 805 and the resistive differences then are a proportional function of the strain of beam 805, caused by the strain applied to leaf 803.

In one embodiment, a whetstone bridge configuration of more than one strain gauge 806 may be provided either to leaf 803 or to beam 805, or to both if structure 802 is used instead of a single leaf. Likewise, there may be gauges 806 applied to the underside of supporting leaf 803 and/or beam 805 as well as to the side of each structure visible in this example. In a preferred embodiment where structure 802 is employed, beam 805 and leaf 803 shall be of length and thickness proportional to one another such that the stain caused by deflecting leaf 803 caused a predictable deflection and strain to beam 805 as measured by strain gauges 806.

In this embodiment, tool 800 further supports a tubular body 801 having a predetermined diameter and a tube wall 804 of a predetermined thickness such that the inside diameter of tubular structure 801 is large enough to encompass the maximum allowed flex for structure 802. In this case, tubular body 801 is optionally closed at one end by an end cap 807 except for an opening 809 provided there through and adapted to allow exposure of tip 808 and to enable limited travel of tip 808.

Tubular body 801 and end cap 807 provide protection for leaf structure 803 and beam 805 from damage and over flex to the point of damage to material memory and/or resistive damage to strain gauge circuits from repeated over flexing. If dial tip 808 is electrically isolated from tubular body 801, then contact between the two could result (closing circuit) in an audible (beep, etc.) or visible (light) warning that the two components have come into contact with each other during operation indicating an over travel condition beyond an acceptable travel limit for the tip.

Housing 810 is adapted to contain all of the required circuitry to sense voltage differences of the gauges and to convert those values to digital measurement values and to wirelessly transmit the results to a local display unit. In a preferred embodiment, tolerance capability of tool 800 and of tool 700 may be refined through calibration to + or −0.0001″ or metric equivalent.

In a preferred embodiment, both tools 700 and 800 may be calibrated before use by providing a “0” setting button that may be automatically or manually set when there is no strain on the tool but the tool tip is touching a surface. In another embodiment, a calibration method may be employed that incorporates a slope or angle bar of some predetermined length and slope such that the tool may be mounted adjacent thereto on a slidable apparatus or table that is parallel to within a predetermined tolerance. By sliding the tool along the angle bar with tip against the known slope, the voltage differences of the resistance measured can be equated within the unit to the actual measurement differences along predetermined equidistant points. In this way a calibration table may be created and employed in the process of converting voltage differences into actual deflection amounts. Likewise, temperature differences that may subtly affect voltage levels may also be figured into calibration and used to refine results during operation.

In one embodiment, instead of using resistive strain gauges on leaf 702 or 803 of FIGS. 7 and 8 respectively, a capacitance structure is provided using a fixed electrode placed in a parallel relationship to an unstrained leaf by way of a fixed bridge. The gap between the fixed electrode and the leaf creates a capacitor that changes proportionally to the amount of deflection of the leaf. The circuitry measures the resulting capacitance and uses this data to calculate the amount of deflection of the tip and leaf.

In both capacitance and resistive models, the circuitry within the respective tools records the values repeatedly according to a predetermined frequency of measurement. Transmission rate may be configured accordingly and may be refined to transmit readings only when a previous reading has changed or at the first detection of a reading other than the last value transmitted. In this way measurements involving linear, arc, or annular travel of the tool tip indicator over a material surface may detect slopes, angles, bowing, surface deflection, out-of-round, flatness, and other important measurement types.

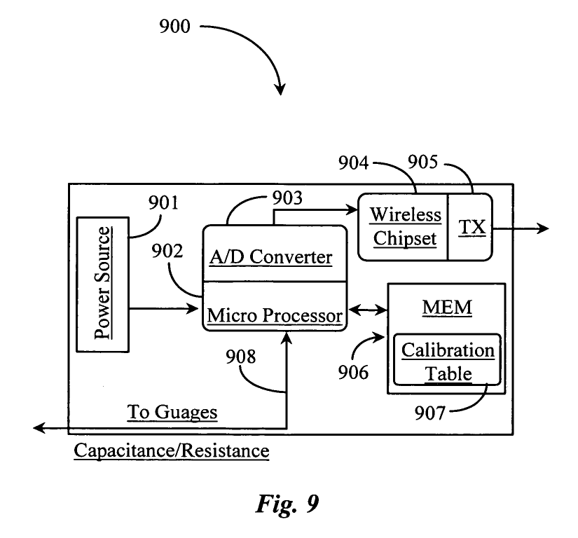

FIG. 9 is a block diagram illustrating components of tools 700 and 800 of FIGS. 7 and 8 according to an embodiment of the present invention. A circuitry block 900 is illustrated herein and logically includes the basic components for practice of the present invention. Circuitry 900 may be somewhat analogous to adapter 201 described with reference to FIG. 2 above with certain modifications for use in a capacitance measurement or resistive measurement embodiment. Circuitry 900 may reside in the respective housings 810 of FIG. 8 or within 701 of FIG. 7 in this current configuration.

Block 900 contains a power source 901 that provides power to the gauges and to a microprocessor 902, which includes an analog to digital A/D converter 903. As required by the resistive or capacitive technique used to measure the deflection of the leaf, signals 908 provide the appropriate stimulus and receive the response that is then processed by the A/D converter 903 and microprocessor 902.

Microprocessor 902 processes the deflection measurement with the calibration table 907 contained in an accessible memory device 906. A wireless transmission chipset 904 is provided and includes at least a transmission TX circuitry for transmitting the result data to a local display unit (not illustrated). Chipset 904 and TX 905 may be onboard microprocessor 902 without departing from the spirit and scope of the present invention.

In one embodiment, the transmission may be through an SPC port as further described above with other tool types. The main difference in this embodiment is the processing of the resistance voltage data or capacitance values and equating those results with appropriate measurement values found in the calibration table. The wireless transmission may be over the ISM band. Bluetooth™ and Zigby™ wireless protocols may also be incorporated without departing from the spirit and scope of the present invention.

The method and apparatus of the present invention according to the various embodiments, some of which have been detailed above should be afforded the broadest interpretation under examination. The spirit and scope of the invention shall be limited only by the following claims.

What is claimed is:

1. A system for acquiring and displaying data in a measurement process, comprising:
a local display unit enabled for wireless data reception; and
a measuring tool for acquiring measurement data, the tool enabled for wireless data transmission;
characterized in that the acquired data is transmitted from the measuring tool to the local display unit and displayed thereon.

2. The system of claim 1 wherein the wireless data reception and transmission is conducted over a radio frequency connection, an infrared connection, or an ultrasonic connection.

3. The system of claim 1 wherein the wireless data reception and transmission is carried over a radio frequency connection and the band is the industrial scientific and medical (ISM) band.

4. The system of claim 1 wherein the local display unit is magnetized on a portion thereof for convenient mounting on a metal display surface.

5. The system of claim 1 wherein the local display unit is a calculator with an existing data input port enabled to receive the measurement data through a plug-in wireless adapter.

6. The system of claim 1 wherein the local display unit is a calculator with an internal wireless chip and circuitry for reception of the measurement data.

7. The system of claim 1 wherein the measuring tool is one of a micrometer, a caliper, a bore gauge, a dial indicator, an inclinometer, a protractor, a level, or a drop indicator having internal wireless chipset and circuitry enabling wireless data transmission.

8. The system of claim 1 wherein the measuring tool is one of a micrometer, a caliper, a bore gauge, a dial indicator, an inclinometer, a protractor, a level, or a drop indicator having an existing output data port enabled to transmit the measurement data through a plug in wireless adapter.

9. The system of claim 1 wherein the local display unit has calculative capabilities adapted to perform calculations using received measurement data as one or more variables in a calculation.

10. The system of claim 1 wherein fabrication involves mounting one or more work pieces to a machine tool and fabricating one or more features thereon the work piece features fabricated subject to measurement while mounted.

11. The system of claim 1 used in machine-assisted production.

12. The system of claim 1 further comprising additional measuring tools adapted to communicate to a single local display unit.

13. The system of claim 12 wherein each additional tool is physically adapted for communication with the local display unit as required using a modular adapter.

14. The system of claim 1 wherein the local display unit and measuring tool use frequency hopping to manage communication.

15. A wireless communication adapter for enabling a measuring tool to transmit measured data to a local display unit comprising:
a chipset and circuitry for enabling wireless transmission of measurement data;
a power source; and
a connector for plugging the adapter to a port on the tool.

16. The wireless communication adapter of claim 15 wherein the power source is a battery cell.

17. The wireless communication adapter of claim 15 wherein the chipset includes a memory device.

18. The wireless communication adapter of claim 15 wherein the chipset includes receive-circuitry in addition to transmit-circuitry.

19. The wireless communication adapter of claim 15 wherein the port on the tool is a statistical process control port.

20. The wireless communication adapter of claim 15 wherein the port on the tool is a universal serial bus port.

21. The wireless communication adapter of claim 15 wherein the connector includes a power pin and a command pin for deriving power from the tool and for sending commands to the tool through the port on the tool.

22. The wireless communication adapter of claim 21 wherein the port on the tool is a statistical process control port.

23. A method for displaying data measured from a work piece by a measuring tool, comprising steps of:
(a) positioning the measurement tool to take a measurement of a feature of the work piece;
(b) recording the measurement data;
(c) transmitting the acquired data wirelessly to a local display; and
(d) displaying the data on the local display.

24. The method of claim 23 wherein in step (a) the measurement data is acquired from a feature of a work piece mounted in a machine tool.

25. The method of claim 23 wherein in step (a) the tool position renders the display or readable face of the tool not visible to an operator of the tool.

26. The method of claim 23 wherein in step (c) the transmitting step causes a mode shift from a power conservation mode or sleep mode to an active wireless transmission mode.

27. The method of claim 23 wherein in step (c) transmitting the data occurs repeatedly over one or more channels for a predetermined and timed sequence.

28. The method of claim 23 further comprising a step (e) for acknowledgement of transmission success, the acknowledgement sent back to the tool.

29. The method of claim 23 wherein the local display is one of a liquid crystal display or a light emitting diode display capable of numeric display capability, graphic display capability, or both numeric and graphic display capability.

30. The method of claim 23 further comprising a step for using the received data as a variable in a calculative sequence.

31. The system of claim 3 wherein the wireless protocol used is Bluetooth™ or Zigby™.

32. The system of claim 1 wherein the measurement tool is a tool adapted to monitor resistance of a strain gauge and to record differences in resistance caused by deflection of a leaf spring supporting the strain gauge.

33. The system of claim 32 wherein the leaf spring supports more than one strain gauge.
